(19) United States
(12) Patent Application Publication
(10) Pub. No.: US 2025/0072568 A1
(43) Pub. Date: Mar. 6, 2025

(54) METHOD OF MANUFACTURING A SOLE UNIT

(71) Applicant: ON CLOUDS GMBH, Zürich (CH)

(72) Inventors: Johannes VOELCHERT, Zürich (CH); Lukas KELLER, Zürich (CH)

(73) Assignee: ON CLOUDS GMBH, Zürich (CH)

(21) Appl. No.: 18/816,602

(22) Filed: Aug. 27, 2024

(30) Foreign Application Priority Data
Aug. 31, 2023 (CH) 000936/2023

(51) Int. Cl. A43D 86/00

(52) U.S. Cl. CPC A43D 86/00

(57) ABSTRACT

A shoe, a sole unit (1) and a method of manufacturing the sole unit (1) having a midsole (2) and an outsole (3) being connected to the midsole (2). The method includes providing a midsole (2) having a first surface (21) configured to face an upper (4), an opposite second surface (22) and a peripheral edge surface (23). The method further includes melting a polymer composition at a first temperature to provide a molten polymer composition. The method further includes applying the molten polymer composition on the second surface (22) of the midsole in the form of a filament (5) forming a plurality of loops (L1, L2, L3, L4, L5, L6) on the second surface (22), thereby forming an outsole (3).

### CROSS-REFERENCE TO RELATED APPLICATIONS

Swiss Patent Application Nos. CH 000936/2023, filed 31 Aug. 2023, the priority document, corresponding to this invention, to which a foreign priority benefit is claimed under Title 35, United States Code, Section 119, and its entire teachings are incorporated, by reference, into this specification.

### FIELD OF THE DISCLOSURE

The present disclosure relates to a method of generating a sole unit and a shoe comprising such a sole unit.

### BACKGROUND OF THE DISCLOSURE

A typical sole unit includes a midsole and an outsole. The midsole and the outsole may be used to obtain different properties. For example, the midsole may be used to obtain mechanical stability and cushioning, while the outsole may be used as a ground-contacting unit. The outsole may be designed to enhance traction on the ground and to prevent wear of the midsole.

Different processes have been developed to attach the outsole to the midsole. Traditionally, the outsole is attached to the midsole in a cementing process, which involves the use of a chemical glue. The cementing process is labor intensive and energy intensive. A further disadvantage is that the chemical glue may be hazardous and environmentally unfriendly. Additionally, the traditional approach requires two distinct steps for manufacturing the sole unit, namely manufacturing the outsole and subsequently attaching the outsole to the midsole. This makes the process labor intensive. A further disadvantage is that the process makes fine-tuning of the properties of the outsole challenging. Typically, a given outsole material is applied to the midsole, often as a single piece. Thus, obtaining different properties in different areas of the sole unit may be challenging.

Furthermore, different materials have traditionally been used for the outsole, including rubber. The outsole materials are processed in a vulcanization process, which requires sustained heat and pressure. The process is therefore energy and labor intensive.

Furthermore, conventional outsoles may be formed by initially extruding, laminating, calendaring, or otherwise forming a sheet of material and then cutting the outsole from the sheet of material. This cutting process produces scrap material that is either discarded or recycled.

Accordingly, there is a need to reduce waste, raw material and energy consumption. There is also a need to increase the manufacturing flexibility and to decrease the time required to manufacture a sole unit.

### SUMMARY OF THE DISCLOSURE

It is the general object of the present invention to advance the state of the art in the field of manufacturing sole units and preferably to overcome the disadvantages discussed above fully or partly. It is further the object of the invention reduce the time, cost, labor, environmental footprint and/or material required to manufacture a sole unit. It is further the object of the invention to improve the mechanical properties of an outsole, in particular with respect to traction and durability. It is a further object to provide a method, which allows fine-tuning the properties of the outsole in a flexible and expedient manner. Finally, it is a further object to enhance the recyclability of the sole unit and of shoes more broadly.

The general object is achieved by the subject-matter of the independent claims. Further advantageous embodiments follow from the dependent claims and the overall disclosure.

In a first aspect, the invention relates to a method of manufacturing a sole unit having a midsole and an outsole being connected to the midsole. The method comprises providing a midsole having a first surface configured to face an upper, an opposite second surface and a peripheral edge surface. The method further comprises melting a polymer composition at a first temperature to provide a molten polymer composition. The method further comprises applying the molten polymer composition on the second surface of the midsole in the form of a filament forming a plurality of loops on the second surface, thereby forming an outsole.

The method according to the first aspect allows the midsole to be formed and attached directly to the midsole in a single operation, without the need for an additional, separate step of manufacturing the outsole and then attaching it to the midsole. Further, it is possible to attach the outsole to the midsole directly, without the need for any adhesives such as cement or a glue. The outsole may also be fine-tuned and, for example, individualized, depending on the specific needs of an individual wearer. Material waste is also minimized because it is possible to avoid any scrap or waste material. Further, by applying the molten polymer composition on the second surface in the form of a filament forming a plurality of loops on the second surface, it is possible to achieve desirable mechanical properties (e.g. high mechanical strength and good traction) while at the same time minimizing the amount of material used. Further, the time required to manufacture the outsole may also be minimized, in part because it is possible to print large areas of outsole in a short period of time. As an example, it is possible in some variants to apply the loops on the second surface in such a way that they form a plurality of intersection points, which confer mechanical strength. Thus, it is not necessary to apply the material such that an essentially through-going layer of material is formed (e.g. by applying, e.g. in a meander-type shape, parallel lines adjacent to each other and contacting each neighboring line fully), which may be time-consuming. Rather, it is possible to apply the loops such that a limited number of gaps between adjacent loops is formed. The shape of the loops and the intersections between the loops may still be sufficient to impart sufficient mechanical strength.

In is understood that in the sole unit manufactured according to the disclosed method, the outsole is connected to the midsole. Typically, the outsole is connected directly to the midsole. In other words, the molten polymer composition is typically applied directly on the second surface of the midsole. In still other words, after application, the outsole typically contacts the midsole directly, without any adhesive arranged between the outsole and the midsole. Depending on the application, the outsole may be entirely free of adhesives, such as glues or cement. Free of adhesives, in this context, may for example mean that the sole unit contains less than 0.5 wt %, preferably less than 0.1 wt %, more preferably less than 0.01 wt %, even more preferably less than 0.001 wt %, adhesive, such as glue or cement. In other words, the method typically does not include application of an adhesive to the midsole. For example, the method may include application of less than 0.5 wt %, preferably less than 0.1 wt %, more preferably less than 0.01 wt %, even more preferably less than 0.001 wt %, adhesive with respect to the weight of the sole unit on the midsole.

The molten polymer composition is applied on the second surface of the midsole, typically through at least one nozzle. More specifically, the molten polymer composition is applied in the form of a filament forming a plurality of loops on the second surface. In other words, when the molten polymer composition in the form of a filament contacts the second surface, the filament forms a plurality of loops on the second surface. In still other words, the molten polymer composition is applied in the form of a filament on the second surface of the midsole such that the filament forms a plurality of loops on the second surface. This may be realized in a number of different ways. For example, it is possible to extrude the molten polymer composition in the form of a filament, which may for example be essentially straight after extrusion and before contacting the second surface, and to apply that filament on the second surface in the form of a plurality of loops. In this example, it is possible to apply an essentially linear filament on the second surface and, while applying the filament on the second surface, to move the second surface with respect to the nozzle in circling motions, so that the previously straight filament is laid on the second surface in the form of a plurality of loops. Depending on the application, the filament may, after exiting the nozzle and before contacting the second surface, be essentially straight. It is also possible that the filament, after exiting the nozzle and before contacting the second surface, may be helical or at least partially helical. Thus, the filament may be applied through the nozzle such that the filament is helical or at least partially helical before contacting the second surface, and that the filament forms a plurality of loops on the second surface, i.e. when it contacts the second surface. The plurality of loops formed on the second surface may be formed from the helical filament. For example, when the filament is helical before contacting the second surface, and the helical filament is applied on the second surface while the nozzle is moved relative to the second surface (e.g. moved linearly, although two- or even three-dimensional relative movements are possible as well), a number of n helices may form a number of n loops on the second surface. Specifically, one turn of the helix may form one loop on the second surface. Thus, the loop on the second surface may for example be seen as an essentially collapsed and optionally distorted helix. Depending on the application, the loop may be an essentially but not fully collapsed helix because at the intersection point defining a closure of the loop, the two overlapping regions of the filament may fuse, i.e. merge, but may, depending on the application, still form a bulge, as discussed in further detail below. In conclusion, the filament typically forms the plurality of loops when in contact with the second surface. The filament may additionally already form the plurality of loops before contacting the second surface, but this is not necessary.

A loop as used herein is a section formed by the filament, which starts at a crossing, extends along the filament and arrives again at the same crossing. Typically, the loops are round and particularly essentially circular. It is understood that the precise shape of the loop may be influenced e.g. by the speed of a relative movement of the second surface with respect to the nozzle and/or by the speed of extrusion of the molten polymer composition through the nozzle. Thus, in some embodiments, at least 80%, preferably at least 95%, more preferably at least 98%, by length of a perimeter of each loop may be round, and up to 20%, preferably up to 5%, more preferably up to 2%, by length of the perimeter of each loop may be angular. For example, at a crossing, which defines the start and end of a respective loop, the respective loop may be angular, for example the filament may define an angle from 110° to 180°, preferably from 150° to 170°. Typically, each loop is round, comprising less than five edges, preferably less than three edges, more preferably exactly one edge. Typically, the loops are not inter-looped, respectively entangled or chain linked with each other. In contrast, the loops are typically arranged partially on top of each other, respectively stacked on each other.

A crossing as used herein is a structure at which the filament crosses and contacts itself. That is, a first section of the filament (such as an upper filament section) may cross a second section of the filament (such as a lower filament section). Depending on the application, a crossing may be formed by one or more filament sections. For example, a crossing may be formed from two filament sections forming together a loop, i.e. the crossing is formed by a single loop. As another example, a crossing may also be formed from two filament sections forming different loops, i.e. such a crossing is formed by two or more overlapping loops. Typically, the loops are consecutively arranged along the filament path one after another.

A crossing may be formed by two filament sections crossing each other. Depending on the application, it is also possible that more than two filament sections may overlap to form a single crossing. Thus, in some embodiments, at least one, or the majority (i.e. at least 50%), or at least 75%, or even all of the crossings consist of two filament sections which cross each other once. In some embodiments, a portion of the crossing formed by the filament comprises, or consists of, more than two filament section crossing each other, i.e. at the same position.

Depending on the application, the crossings may relate to a pre-cured outsole. The crossings may further be maintained throughout further steps. For example, the crossings may also relate to the post-cured outsole. Depending on the nature of the post-processing steps, the crossings may also relate to the post-processed outsole.

The molten polymer composition is applied in the form of a filament. Depending on the application, the filament may be a continuous filament. It is possible to apply two or more separate continuous filaments, or a single continuous filament may be applied. For example, a single and distinct continuous filament may be applied on each distinct section of the midsole. In this embodiment, the different continuous filaments may have the same or different material compositions. Different material compositions may be used to impart different properties in different sections of the outsole. Alternatively, in some embodiments, the entire outsole may be formed of a single filament.

Depending on the application, a continuous filament may form at least 100, in particular at least 1000, in particular at least 5000 loops. It is noted that this primarily refers to the loops as they are applied on the second surface. In other words, this embodiment may relate to the pre-cured outsole or to the post-cured outsole. Depending on the density of the loops and the nature of possible subsequent processing steps (e.g. second curing step, embossing, etc.), it is possible that the loops may no longer be clearly visible in the post-processed outsole. Nevertheless, when applied on the second surface, a continuous filament may form the indicated number of loops.

The filament may comprise multiple filament sections, such as for example an upper and lower section as described herein, or also an intermediate section being for example arranged between two adjacent loops, respectively between an upper section of a first crossing of a first loop and a lower section of a second crossing of a second loop. There may also be a loop forming section, which may form together with an upper section and lower section a loop.

The material composition of the molten polymer composition may be constant throughout the length of the filament, or it may change throughout the length of the filament. The latter embodiment may, for example, be achieved by varying the material composition over time, as the filament is extruded from the nozzle. An advantage of this embodiment is that different material properties may be achieved, while at the same time ensuring a high number of crossings and thereby achieving high structural stability.

Depending on the application, the filament may have a filament thickness from 0.01 mm to 5 mm, preferably from 0.01 mm to 0.2 mm, preferably from 0.05 mm to 0.15 mm. The exact structure, shape and geometry of the filament depends on different factors, which typically include the nozzle and the speed of extrusion. In some embodiments, the filament extruded from the nozzle has a round, typically a circular, cross section. This cross section typically refers in particular to the filament after being extruded and before contacting the second surface. Depending on the application, the cross section may be maintained by the filament once it contacts the second surface, or it may be altered, e.g. by post-processing steps such as embossing.

In some embodiments, the molten polymer composition in the form of a filament may be provided to the second surface with a velocity of at least 0.1 m/s, in particular at least 0.5 m/s, more particular at least 0.7 m/s. In some embodiments, the molten polymer composition in the form of a filament may be provided to the second surface with a velocity of between 0.1 m/s to 10 m/s, in particular between 0.1 m/s to 5 m/s, more particular between 0.1 m/s to 1 m/s. In some embodiments, the molten polymer composition in the form of a filament may be provided to the second surface with a velocity of between 0.5 m/s to 10 m/s, in particular between 0.5 m/s to 5 m/s, more particular between 0.5 m/s to 1 m/s. In some embodiments, the molten polymer composition in the form of a filament may be provided to the second surface with a velocity of between 0.7 m/s to 10 m/s, in particular between 0.7 m/s to 5 m/s, more particular between 0.7 m/s to 1 m/s.

The outsole is formed by applying the molten polymer composition in the form of a filament forming a plurality of loops on the second surface. In other words, the outsole comprises a plurality of loops. The outsole may comprise, or consist of, the molten polymer composition applied on the second surface. For example, the molten polymer composition may make up at least 50 wt %, preferably at least 75 wt %, more preferably at least 85 wt %, more preferably at least 95 wt %, for example 100 wt %, of the outsole. Typically, the outsole is free of adhesives such as cement or glue.

Typically, the molten polymer composition is applied to more than 10%, preferably more than 25%, more preferably more than 40%, of the second surface of the midsole. Depending on the application, it may also be applied to more than 60%, such as more than 80%, such as more than 90%, of the second surface, or it may be applied to less than 60% of the second surface of the midsole. For example, it is possible to specifically apply the molten polymer composition only to those regions of the midsole which are exposed to maximum tension and which require most traction.

Generally, the outsole is formed by applying the molten polymer composition on the second surface. Thus, the outsole generally refers to the outsole as it is being formed by application of the molten polymer composition on the second surface and optionally on the peripheral edge surface. In typical embodiments, the method further comprises a first curing step. In these embodiments, the outsole formed after application of the molten polymer composition on the second surface (and optionally on the peripheral edge surface) is a pre-cured outsole, and the outsole obtained after the first curing step is a post-cured outsole. In other words, in these embodiments, the method comprises subjecting the pre-cured outsole to a first curing step to obtain a post-cured outsole. Typically, the first curing step comprises solidification by cooling the molten polymer composition below its melting temperature. The first curing step may for example comprise cooling the applied molten polymer composition for at least 1 second, typically at a temperature of at least 10° C. less, preferably at least 25° C. less, more preferably at least 70° C. less, than the melting point of the polymer composition. The first curing step may comprise cooling the applied molten polymer composition for at least 2 seconds, preferably at least 5 seconds, at a temperature from 0° C. to 100° C., preferably from 10° C. to 50° C. Typically, during the first curing step, the pre-cured outsole may be at least partially, or even fully, hardened. Typically, the first curing step leads to at least partial, preferably full, solidification of the molten polymer composition.

In some embodiments, the method further comprises one or more post-processing steps. Typically, the post-cured outsole is post-processed to obtain a post-processed outsole. The post-processing may include a second curing step and/or application of a traction pattern. The application of the traction pattern may, for example, comprise embossing. The traction pattern may be applied on a pre-cured outsole or a post-cured outsole. It is also conceivable that the traction pattern is applied when the polymer composition is still partially molten and already partially hardened. In other words, the traction pattern may be applied before, simultaneously with, or after the first curing step. When the traction pattern is applied to the post-cured outsole, the step of applying the traction pattern typically includes heating, for example at least partially re-melting, the post-cured outsole. Additionally, or alternatively, it is also possible to maintain the applied molten polymer composition in a plastic state before applying the traction pattern.

The second curing step may in some variants be used to harden, preferably to fully harden, the outsole. The second curing step may in some variants include the steps outlined above in the context of the first curing step. The first curing step and the second curing step may be identical, or they may be different from each other. Typically, the second curing step includes cooling the post-cured outsole at a temperature from 10° C. to 40° C., for example for at least 30 seconds. Additionally, or alternatively, the second curing step may include irradiating the post-cured outsole, e.g. with UV radiation and/or plasma radiation. If the polymer composition comprises a crosslinking agent, the second curing step may involve crosslinking reactions, which may for example be initiated by radiation (e.g. UV radiation) and/or heating. Depending on the crosslinking agent, the crosslinking may also occur spontaneously. The second curing step is typically performed after the application of the traction pattern, but may also be performed before or simultaneously with this step.

The midsole used in the method and in the sole unit disclosed herein has a first surface and an opposite second surface. The peripheral edge surface is arranged between the first and the second surface. Typically, the first surface contacts the peripheral edge surface along a first bordering contour. Typically, the second surface contacts the peripheral edge surface along a second bordering contour. The first surface typically faces an upper or is configured to face an upper. Depending on the application, the midsole may either be provided separately or it may be connected to an upper. In the latter embodiment, the first surface faces the upper and the second surface faces away from the upper. Thus, the first surface of the midsole may also be labelled as an upper surface of the midsole and the second surface may also be labelled as a lower surface of the midsole. The lower surface is typically ground-facing. Typically, the first surface and the second surface are each larger than the peripheral edge surface. Typically, the midsole comprises a medial side and a lateral side. The midsole may further comprise a heel section with a heel edge, a forefoot section with a tip and a midfoot section being arranged between the heel section and the forefoot section. The heel edge represents along a longitudinal direction the rear delimitation of the midsole. The tip is oppositely arranged to the heel edge and represents a foremost delimitation of the midsole. The peripheral edge surface represents on the medial and lateral side the peripheral delimitation of the midsole.

As used herein, polymer composition refers to a composition of one or more different polymers. Typically, the polymer composition comprises at least 50 wt %, preferably at least 75 wt %, more preferably at least 85 wt %, more preferably at least 95 wt %, more preferably essentially 100 wt %, of one or more thermoplastic polymers. Depending on the application, the polymer composition may comprise one or more crosslinking agents, e.g. in a ratio relative to the total weight of the polymer composition of up to 5 wt %, preferably from 0.001 wt % to 2 wt %, more preferably from 0.001 wt % to 0.5 wt %. The crosslinking agent may for example be used to achieve higher rigidity while still ensuring sufficient viscosity during application of the polymer composition. The polymers included in the polymer composition may for example be selected from polyamide, polyether block amide, polyurethane and/or polyester or a combination thereof. Alternatively, or in addition also an at least partially biodegradable polymer or polymer composition is possible as well. In some variants, one or more polymers may be an elastomer and/or a duromer. In some embodiments, the polymer composition comprises thermoplastic polyurethane (TPU), polyamide, a thermoplastic elastomer (TPE), such as PEBAX®, or any combination thereof. PEBAX® as used herein refers to a polyether block amide. It is a block copolymer.

The polymer composition may be chosen independently of the midsole, or it may be chosen in accordance with the midsole. For example, in some embodiments, the molten polymer composition and the midsole may be made of the same material. This may, for example, facilitate recycling of the sole unit. In some embodiments, the upper is made of the same material as the polymer composition. Once again, recycling is facilitated. It is also possible that the molten polymer composition and the midsole have at least one material component in common. The material component may for example be a monomer. It is possible that a shared monomer is present in both the polymer composition and in the midsole, but that this shared monomer is combined with a first other monomer in the polymer composition and with a second other monomer (being other than the first monomer) in the midsole. In this case, the polymer composition and the midsole have at least this monomer as a common material component in common. Preferably, the material component that the polymer composition and the midsole have in common makes up at least 50 wt %, preferably at least 75 wt %, more preferably at least 90 wt %, more preferably at least 95 wt %, of the outsole. Further, the material component that the polymer composition and the midsole have in common may make up at least 50 wt %, preferably at least 75 wt %, more preferably at least 90 wt %, more preferably at least 95 wt %, of the midsole. The indicated ratios by weight refer to the structural chemical units that the polymer composition and the midsole have in common. Thus, for example, if the polymer composition consists of a copolymer made of monomers A and B (with A making up 75 wt % of the polymer composition and with B making up 25 wt % of the polymer composition), and the midsole consists of a copolymer made of monomers A and C (with A and C each making up 50 wt % of the midsole, and with A, B and C being different from each other), the polymer composition and the midsole would have monomer A in common, and the common material component would make up 75 wt % of the outsole and 50 wt % of the midsole.

The polymer composition is molten at a first temperature to provide the molten polymer composition. The first temperature is typically selected in accordance with the melting point or the melting range of the polymer composition, and it is typically chosen such that the polymer composition is molten and is sufficiently viscous to be applied to the shaping carrier by means of the at least one nozzle. The first temperature may also comprise a temperature range. The typical temperature range is thereby between 100 degrees Celsius and 300 degrees Celsius, preferably in a range between 160 degrees Celsius and 260 degrees Celsius. For example, if a thermoplastic polyurethane, such as Desmopan 2790a® or Desmopan 9392A® (Covestro) is used as the polymer composition, the first temperature may have a value for example from 210 to 250° C., in particular 225 to 240° C., such as 235° C.

Typically, a plasticizing unit is used, which may include a plurality of, in particular three, consecutively arranged temperature zones. Each temperature zone may have a separately controllable heating element. In particular, before it exits the at least one nozzle, the polymer composition may for example pass through a first temperature zone, then a second temperature zone with a temperature that is higher than the temperature of the first temperature zone, and then optionally a third temperature zone with a temperature that is higher than the temperatures of the first and second temperature zones. For example, the first temperature of the first temperature zone may be in a range from 180° C. to 200° C., the second temperature of the second temperature zone may be in a range from 220° C. to 240° C., and optionally the third temperature of the third temperature zone may be in a range from 230° C. to 240° C. To be able to apply the molten polymer composition in a controlled manner, a depositing unit may be used, which comprises a dosing head comprising the at least one nozzle. The polymer composition, being molten in the plasticizing unit is typically applied via an outlet of the at least one nozzle on the shaping carrier in form of a filament forming a plurality of loops on the shaping carrier. The outlet may be an opening of the nozzle with a diameter that varies over the course of the outlet.

Depending on the application, during application of the molten polymer composition, the midsole (particularly the second surface of the midsole) is moved relative to a nozzle through which the molten polymer composition is applied. Additionally, or alternatively, the nozzle may be moved relative to the midsole (particularly the second surface of the midsole). It is also possible to move both the midsole and the nozzle, and to move them relative to each other. Depending on the application, different speeds of relative movement are possible. For example, the second surface may be moved relative to the nozzle with a speed of 0.5 m/min to 20 m/min, in particular 1 m/min to 10 m/min, in particular 1.5 m/min.

It is generally understood herein that the term “comprising” is interpreted as meaning that it includes those features following this term, but that it does not exclude the presence of other features, as long as they do not render the claim unworkable. On the other hand, if the wording “consist of” is used, then no further features are present in the corresponding apart from the ones following said wording.

In some embodiments, the molten polymer composition is applied on the second surface in the form of a filament forming a plurality of partially superimposed loops extending along a filament path. A filament path as used herein describes the path the filament follows through the outsole being formed. In some embodiments, the filament path may be delimited by two opposing hypothetical boundary lines between which the superimposed loops formed extend. In certain embodiments, these two hypothetical boundary lines contact the outer periphery of the loops formed by the continuous filament. The two opposing hypothetical boundary lines may in certain sections extend linearly and/or in parallel to each other. However, the two hypothetical boundary lines and thus the filament path, may also form curves.

Partially superimposed loops are loops which are partially arranged on top of each other and thus partially overlap. However, the loops are not completely aligned with each other, but offset to each other. In other words, the loops partially overlap with each other.

In some embodiments the plurality of superimposed, e.g. partially superimposed, loops are stacked on top of each other along the filament path. In some embodiments, the plurality of superimposed loops form a stacked structure. It is understood that the term “stacked on top of each other along the filament path” means that each subsequent (i.e. downstream) loop is arranged or shifted further downstream than the previous upstream loop. During production, this means that each downstream loop is formed after its upstream loops.

In some embodiments, the plurality of partially superimposed loops define a plurality of crossings at which the filament crosses itself and forms a material-bonded, in particular fused, connection with itself.

A fused connection of the filament is a connection being formed by directly fusing two sections of the filament together. A fused connection is devoid of an additional, i.e. external adhesive. A fused connection may be formed by providing at least one, or even both, of the filament sections in molten form. During a curing step (i.e. e.g. cooling below the filament melting point), a direct material-bonded connection is formed, which is devoid of external, respectively additional, adhesives. The curing step could for example be the first curing step.

In some embodiments, the method further comprises the step of pre-conditioning an area of the second surface of the midsole before applying the molten polymer composition to that area. The pre-conditioning may, for example, comprise activating that area. Thus, the pre-condition may serve to enhance the mechanical strength and durability of the outsole, e.g. by enhancing fusing. The pre-conditioning may, for example, comprise irradiating the area, e.g. with plasma, and/or heating the area, e.g. using a hot air stream. The hot air stream may, for example, be the hot air stream exiting through the air exit openings of the nozzle.

In some embodiments, the molten polymer composition is applied on the second surface at a filament crossing density of at least 200 crossings per cm², in particular at least 500 crossings per cm², more particularly at least 800 crossings per cm². In other words, after application of the molten polymer composition, a filament crossing density on the second surface may be at least 200 crossings per cm², in particular at least 500 crossings per cm², more particularly at least 800 crossings per cm². The surface in cm² to which the indicated density relates, is the surface area in cm² of the second surface on which the filament has been applied. It refers to the total surface area on which the filament has been applied, including any possible areas which are not in direct contact with the filament, but which are e.g. surrounded by the filament. In other words, the surface area is not limited to those parts of the second surface which are in direct contact with the filament. In still other words, for example, the molten polymer composition may be applied on the second surface at a filament crossing density of 200 crossings per cm², in particular at least 500 crossings per cm², more particularly at least 800 crossings per cm².

In some embodiments, the molten polymer composition may be applied on the second surface at a filament crossing density of at least 200 crossings per cm², in particular at least 500 crossing per cm², more particular at least 600 crossings per cm², more particular at least 800 crossings per cm², more particular at least 1000 crossings per cm², even more particular at least 1200 crossings per cm².

In some embodiments, the molten polymer composition may be applied on the second surface at a filament crossing density of 200 to 20000 crossings per cm², in particular of 400 to 10000 crossings per cm², in particular of 500 to 8000 crossings per cm², in particular of 500 to 6000 crossings per cm².

In some embodiments, the molten polymer composition may be applied on the second surface at a filament crossing density of 400 to 20000 crossings per cm², in particular of 500 to 10000 crossings per cm², in particular of 600 to 8000 crossings per cm², in particular of 700 to 5000 crossings per cm², of 800 to 4000 crossings per cm².

The filament crossing density as specified in the present disclosure may for example relate to the pre-cured outsole. The filament crossing density may also relate to the post-cured outsole. Depending on the nature of the post-processing steps, the filament crossing density may also relate to sections of, or even the entire, post-processed outsole.

The number of crossings may be obtained from a corresponding microscopic image of the sole unit, particularly the outsole. For this a 1 cm×1 cm square is arranged on the microscopic image, in particular such that one of the four sides of the square extends through the center of a loop, e.g. such that the loop is divided in half by this side of the square. Such a crossing density provides an increased stability, in particular tearing strength, since any occurring forces are well distributed over a vast amount of crossings. Furthermore, due to the material-bonded connection, forces can be efficiently transmitted through the sole unit. This is particularly advantageous for shoe uppers comprising or consisting of such a sole unit, because forces occurring during running and being exerted on the upper can be transmitted to the sole and thereby support the push-off process of the runner, which improves the runner's performance.

In some embodiments, the molten polymer composition may be applied on the second surface at a filament loop density as defined herein of 1 to 150 loops per cm², in particular 2 to 100 loops per cm², more particular 5 to 80 loops per cm². As used herein, the loop density is the number of loops being formed by the filament per cm². For this measurement, a surface of 4 cm² (2 cm×2 cm square) is arranged such that the center of a loop is aligned with the center of the 2 cm×2 cm square. For determining the loop density, only the number of loops which are completely (and thus not only partially) arranged inside the 2 cm×2 cm square is determined and divided by 4 cm².

The filament loop density as specified in the present disclosure may for example relate to the pre-cured outsole. The filament loop density may also relate to the post-cured outsole. Depending on the nature of the post-processing steps, the filament loop density may also relate to sections of, or even the entire, post-processed outsole.

In some embodiments, the applied filament forms a plurality of fused bulge portions, formed from multiple fused together filament sections of the filament. In other words, the filament is typically applied on the second surface such that it forms a plurality of fused bulge portions, formed from multiple fused together filament sections of the filament.

The fused bulge portions are typically present in the pre-cured outsole. The fused bulge portions may additionally be present in the post-cured outsole. Depending on the nature of the post-processing steps, the fused bulge portions may also still be present in sections or, or even the entire, post-processed outsole.

In particular embodiments, the fused bulge portions are formed from at least two, in particular at least three, in particular at least four, in particular at least five, in particular at least six, filament sections being fused together. It is understood that the fused bulge portions are different from the formed crossings. In particular, fused bulge portions may have a larger cross-sectional area than a crossing, and/or a larger length, i.e. extension in one direction. While a length of a crossing may for example be in the range of 100% to 300%, in particular 100% to 200% of the maximum filament thickness of the filament, respectively of the filament sections of the filament, a length, respectively extension in one direction of a fused bulge portion may be larger than 300%, in particular larger than 500% or even larger than 1000% of the maximum filament thickness of the filament, respectively of the filament sections of the filament. In general, fused bulge portions may be considered as a thickening in the outsole as compared to the individual filament sections and optionally to the crossings. In some embodiments, one or more fused bulge portions may extend along the filament path, e.g. in the filament path direction. In particular embodiments, one or more fused bulge portions may extend along, especially in parallel to, the plurality of loops. In some embodiments, two or more fused bulge portions of the outsole are spaced apart from each other and extend essentially at least over a portion of the outsole in parallel to each other. These embodiments may in particular apply to the pre-cured outsole and may also apply to the post-cured outsole.

In certain embodiments, multiple sections of the formed loops may be fused together in such fused bulge portions. Fused bulge portions generally have the advantage that the tearing strength and the general stability of the outsole being formed is significantly increased. The fused bulge portions may for example be formed by multiple filament sections which merge together at the bulge portion and/or which diverge from each other from the fused bulge portion. The fused bulge portions may in some embodiments have an extension in one direction of 1 mm or more, in particular of 10 mm or more, in particular of 20 mm or more. It is understood that the bulge portion has a larger thickness than the maximum filament thickness of the individual filament sections. The fused bulge portions may in some embodiments also comprise one or more crossings formed by the filament. In such embodiments, the crossings are fused into the fused bulge portion.

In some embodiments, the filament and in particular the loops, define rhombic openings. In other words, the filament and in particular the loops may be applied such that they define rhombic openings. These rhombic openings may be through going openings with respect to the outsole by itself, i.e. they may penetrate through the outsole. Typically, the rhombic openings define blind holes in the sole unit. For example, a bottom section of each rhombic opening may be defined by the second surface and an interior mantle surface of each rhombic opening may be defined by the outsole. In some embodiments, the filament and in particular the loops, define triangular openings. In other words, the filament and in particular the loops may be applied such that they define triangular openings. These triangular openings may be through going openings with respect to the outsole by itself, i.e. they may penetrate through the outsole.

The openings defined in the previous paragraph typically relate to the pre-cured outsole. The openings may additionally relate to the post-cured outsole. Depending on the nature of the post-processing steps, the options may also relate to at least sections of, or even the entire, post-processed outsole.

In some embodiments, the partially superimposed loops are along the filament path arranged one after another and at least some, or the majority (more than 50%), or essentially all, of the superimposed loops, except the last loop (along the filament path) are arranged (e.g. partially arranged) underneath their next adjacently arranged loop. In other words, in such embodiments, the superimposed loops form together a roof tile structure in which the superimposed loops partially overlap and in which starting from the first loop, every loop except the last one is arranged partially underneath its next adjacent loop. Such a structure with fused crossings not only provides for a significantly resistant and stable sole unit, but can also be manufactured relatively casily as will be described further below. The embodiments described in this paragraph refer in particular to the pre-cured outsole, i.e. the outsole as it is being formed after application of the molten polymer composition on the second surface. In other words, for example, the molten polymer composition may be applied on the second surface in the form of a filament forming a plurality of superimposed loops forming together a roof tile structure on the second surface of the midsole. Depending on the application, the embodiments may also apply to the post-cured outsole. In some embodiments, the plurality of loops on the second surface are arranged in the shape of a row of overturned dominoes.

The variants described in the previous paragraph typically relate to the pre-cured outsole, and may also relate to the post-cured outsole. Depending on the nature of the post-processing steps, they may also relate to at least sections of, or even the entire, post-processed outsole.

In the context of the present disclosure, the directional indications “downstream” refer to a direction along the filament path. In contrast “upstream” refers to the opposite direction, i.e. against the filament path. That is, a specific loop B may be arranged downstream of a specific loop A. In the embodiments described in the preceding paragraph this may mean that if loops A and B are arranged directly one after another, the loop being arranged downstream, i.e. loop B, is arranged above loop A, i.e. on top of it. Vice versa, the upstream loop, i.e. loop A, is arranged underneath the downstream loop B. In general, in some embodiments the loops, in particular each loop, may be arranged underneath its adjacent downstream loop.

The filament path may have a filament path direction. This filament path direction may extend from the first loop formed by the filament through the center of each subsequent loop up along the outsole up to the last loop formed by the filament. The filament path direction does not have to be linear, but may also form curves through the outsole. In the filament direction, the loops, in particular each loop, may preferably be arranged underneath its next adjacently arranged loop.

In some embodiments, the partially superimposed loops are along the filament path arranged one after another, wherein the superimposed loops are along the filament path arranged underneath their next adjacently arranged loop. In some embodiments, each partially superimposed loop (except the last loop) is along the filament path arranged underneath their at least 2, at least 5, at least 10, or at least 15, next adjacently arranged loops. In other words, the filament may be applied on the second surface such that each partially superimposed loop (except the last loop) is along the filament path arranged underneath their at least 2, at least 5, at least 10, or at least 15, next adjacently arranged loops. Thus, in such embodiments, the loops form a relatively narrow loop structure which results in an increased number of crossings and thus to a significantly more resistant sole unit. In some embodiments the loops, in particular each loop, may be arranged underneath its at least 2, at least 5, at least 10, or at least 15, adjacent downstream loops.

In some embodiments, each loop formed by the filament defines a maximum clear distance of 5 mm to 50 mm, in particular 5 mm to 30 mm. The maximum clear distance is the maximum length of a straight line extending through the center of the loop through the open area defined by the inner periphery of the filament forming the corresponding loop. For example, if the loop is circular, the maximum clearing distance is equal to the inner diameter of the loop.

In some embodiments, the maximum clear distance of the loops formed by the filament may vary throughout the outsole, in particular by at least 10%, particularly at least 20%, more particularly at least 30%, or by between 10% to 50%, particularly between 20% to 50%. Such a varying maximum clear distance influences the properties of the outsole. For example, a larger maximum clear distance may lead to a larger open area and thus lead to a lighter region. In contrast, a smaller maximum clear distance leads to a decreased open area and a higher loop density, which improves the stability in this region. For example, the outsole may comprise a first area with a plurality of loops in which each loop has a smaller maximum clear distance than each loop in a second area with a plurality of loops, or in which the mean maximum clear distance of the loops is smaller than the mean maximum clear distance of the loops in the second area. It is understood that the outsole may also comprise multiple of such first and second areas.

In some embodiments, the filament and/or filament sections (e.g. individual filament sections which form the loops and/or the crossings), has a maximum filament thickness of 10 μm to 1000 μm, in particular 50 μm to 500 μm, more particular of 50 μm to 300 μm, even more particular of 75 μm to 250 μm. The maximum filament thickness is the maximum cross-sectional extension of the filament, respectively the filament sections. However, it should be noted that the maximum filament thickness is not measured at a fused bulge portion or at a crossing, but rather at a section of the filament where it forms a loop and where is not fused to other sections of the filament. If the filament has a circular cross-section, the maximum filament thickness is equal to the diameter of the filament. This term does however not mean that it refers to the largest filament thickness along the entire filament length, but the term “maximum” means that if the cross-section of the filament is for example rectangular, the maximum filament thickness is given by the diagonal between two corners and not for example by the lengths of the sides of the rectangle, since the diagonal is the largest filament thickness at this position. The embodiments described in this paragraph refer in particular to the filament as it extruded from the nozzle, before contacting the second surface. The embodiments may additionally refer to the filaments of the pre-cured outsole, i.e. after contacting the second surface. Depending on the nature of any possible further processing steps such as curing, the embodiments may or may not also relate to the post-cured outsole.

The variants of possible arrangements and geometries of the loops on the second surface, as described in the present disclosure, typically relate to the pre-cured outsole, and may also relate to the post-cured outsole. Depending on the nature of the post-processing steps, they may also relate to at least sections of, or even the entire, post-processed outsole.

In some embodiments, the superimposed loops of the outsole, particularly of the pre-cured outsole and optionally also of the post-cured outsole, form a regular laying pattern. A regular laying pattern is a laid pattern, which comprises at least one regularly repeating element.

In some embodiments, each crossing is at least formed, or only formed, from a lower filament section of the filament and an upper filament section of the filament. The upper filament section is arranged above, i.e. on top of, the lower filament section. It is understood that the lower and upper filament sections are different sections of the filament, in particular of the same filament, which are along the filament spaced apart from each other. For example, a loop formed by the filament may commence at a lower filament section at a crossing, extend along the loop and end at the upper filament section at this crossing being arranged above the lower filament section. In particular, at least one, or the majority (i.e. more than 50%) or even all of the crossings is/are formed only from a lower filament section of the filament and an upper filament section of the filament.

In some embodiments, the upper filament section at at least one, or at the majority (i.e. more than 50%), or at all crossings, is sank partially into the lower filament section. In such embodiments, the lower filament section may form a concavity, such as a bowl shaped, U shaped or V shaped concavity which accommodates a part of the upper filament section at the corresponding crossing. Such crossings may for example be formed by providing the upper filament section onto the lower filament section while the lower filament section is in a softened, e.g. molten, state. Such crossings provide for an improved stability, in particular tearing resistance, since it forms a stronger connection between the filament sections. In some embodiments, the upper filament section is sank into the lower filament section by between 40% to 90%, in particular by between 50% to 90%, more particular by between 60% to 80% of its maximum filament thickness. The embodiments described in this paragraph may, for example, relate to the post-cured outsole. The embodiments described in this paragraph typically relate to the post-cured outsole and may also relate to the pre-cured outsole. The embodiments typically relate to a pre-processed state, but may also be maintained in a post-processed state.

In some embodiments the upper filament section is at at least one, or at the majority (i.e. more than 50%), or at all crossings, sank such into the lower filament section that the crossing has a height being between 10% to 50%, in particular 15% to 30% larger than the maximum filament thickness. In some embodiments, the height of at least one, or at the majority (i.e. more than 50%), or at all crossings is between 10% to 50%, in particular 15% to 30% larger than the maximum filament thickness. It is understood that the term “height” as used herein is typically perpendicular to the two filament sections crossing each other at the crossing, respectively extends along the thickness of the sole unit. The embodiments described in this paragraph typically relate to the post-cured outsole and may also relate to the pre-cured outsole. The embodiments typically relate to a pre-processed state, but may also be maintained in a post-processed state.

In some embodiments, the height at at least one, or at the majority (i.e. more than 50%), or at all crossings is between 10 to 50 μm, in particular 10 to 30 μm larger, than the maximum filament thickness.

In some embodiments, at least one, or the majority (i.e. more than 50%), or all crossings, have a crossing length, i.e. the total extension of crossing along each filament section of the crossing (i.e. the upper or lower filament section) of between 50 to 500 μm, in particular 50 to 250 μm, more particular 100 to 200 μm.

In some embodiments, the at least one, or the majority (i.e. more than 50%), or even all of the crossings may comprise or be a protuberance. Such a protuberance may generally be formed by the filament. Such a protuberance comprises a height being larger than the maximum filament thickness of the filament. Typically, the height of the protuberance may be between >100% and 200%, in particular >100% to 180%, more particular between 110% and 160%, of the maximum filament thickness of the filament.

In some embodiments, the outsole is formed from a single filament.

In some embodiments, the molten polymer composition is additionally applied on the peripheral edge surface of the midsole. It is typically applied on part of the peripheral edge surface, though it can also be applied to the entire peripheral edge surface. By also applying the polymer composition on the peripheral edge surface, the stability of the outsole may be enhanced. In particular, in some embodiments, the molten polymer composition is applied to the peripheral edge surface such that the applied molten polymer composition covers essentially the entire peripheral edge surface and extends from the first bordering contour (along which the first surface contacts the peripheral edge surface) to the second bordering contour (along which the second surface contacts the peripheral edge surface). The molten polymer composition may be applied on a medial side and/or on a lateral side of the peripheral edge surface.

The molten polymer composition may be applied to one or more different areas of the midsole. For example, in some embodiments, the molten polymer composition is applied to one or more of the following sections of the midsole:
a heel section of the second surface to provide a heel outsole section;
a midfoot section of the second surface to provide a midfoot outsole section;
a forefoot section of the second surface to provide a forefoot outsole section;
a medial section of the peripheral edge surface to provide a medial outsole section;
a lateral section of the peripheral edge surface to provide a lateral outsole section;
a heel section of the peripheral edge surface to provide a heel outsole section; and/or
a forefoot section of the peripheral edge surface to provide a forefoot outsole section.

Thus, for example, the heel outsole section may comprise the polymer composition being applied to the heel section of the second surface and/or to the heel section of the peripheral edge surface. Similarly, the forefoot outsole section may comprise the polymer composition being applied to the forefoot section of the second surface and/or to the forefoot section of the peripheral edge surface.

Depending on the application, each of the sections listed above is formed from less than 100, preferably less than 30, more preferably less than 10, more preferably less than 5 continuous strands, more preferably from one continuous strand.

In some embodiments, the outsole comprises a first area and a second area being different from the first area. It is understood that the outsole may also comprise a plurality of such first areas and a plurality of such second areas. In this case each of the plurality of the first areas may have the same properties but are arranged at different locations and/or are spaced apart from another. Vice versa, the plurality of the second areas may have the same properties but are arranged at different locations and/or are spaced apart from another. Particularly, the first area differs in at least one property from the second area. For example, the different property, such as a physical property, particularly a mechanical property, may be a different mass per area, different maximum clear distance, different loop density, different filament crossing density, mesh size, etc.

Depending on the application, the sections may correspond to or be different from the areas. For example, each section may correspond to exactly one area. However, it is also possible that at least some sections each include more than one area. Conversely, it is also possible that one area spans across two or more regions. In some embodiments, each sections includes at least one, preferably from one two three, areas. For example, a heel section may be a first area having a first set of physical properties and a forefoot section may be a second area having a second set of physical properties.

In some embodiments, the filament crossing density is higher in the first area than in the second area. In certain embodiments, a ratio of filament crossing density in the second area to the filament crossing density in the first area is between 0.05 to 0.5 in particular 0.1 to 0.5. Such embodiments allow to provide areas with an increased stability and decreased flexibility (higher filament crossing density), which may be beneficial in areas which are in use exposed to mechanical forces, such as abrasion, and areas increased flexibility for areas, where a certain flexibility is desirable.

In some embodiments, the loop density in the first area is higher than in the second area. In certain embodiments, the ratio of the loop density in the second area to the loop density in the first area is between 0.05 to 0.6, in particular 0.1 to 0.5. An increased loop density provides for a higher stability, which is beneficial in areas being exposed to high mechanical forces, whereas a decreased loop density leads to a higher mesh size. In an outsole, this may be beneficial for lightweight regions which do not experience maximum traction or wear. Such embodiments are advantageous, because a decreased loop density reduces the overall weight of the outsole and concomitantly allows for a high mechanical strength, traction and durability.

The molten polymer composition may be applied uniformly across the second surface, or it may be applied such that different areas or sections are formed. In some embodiment, the molten polymer composition is applied such that a plurality of elevations are formed. For example, at least five, preferably at least ten, more preferably at least 20, even more preferably at least 50, elevations may be formed. An elevation typically has a surface area of at least 0.5 mm², preferably from 1 mm² to 100 mm². Typically, an elevation has an elevation height of at least 0.5 mm, preferably at least 1 mm. The elevation height is defined as a distance in a direction orthogonal to a plane defined by the second surface of the outsole between the plane defined by the second surface and an outermost point of the elevation. The outermost point of the elevation faces away from the midsole. For example, if the elevation was spike-shaped, the elevation height would be the distance between a tip of the spike-shaped elevation and the plane defined by the second surface.

In some embodiments, the molten polymer composition is applied such that one or more grooves are formed. A groove may for example have a groove height of at least 0.5 mm, preferably of at least 1 mm. The groove height is defined as a distance in a direction orthogonal to a plane defined by the outsole between the plane defined by the outsole and an innermost contour of the groove. The innermost contour of the groove is that part of the groove that is arranged closest to the midsole. In some embodiments, the grooves may act as water drainage grooves. For example, the grooves may extend towards a lateral and/or medial side.

In some embodiments the filament comprises along the loops, in particular along each loop, except the first and last loop, a crossing number as defined herein of at least 10, in particular at least 20, in particular at least 30, in particular at least 50, in particular at least 100, in particular at least 200.

In some embodiments, the filament comprises along the loops, in particular along each loop, except the first and last loop, a crossing number as defined herein of 10 to 5000, in particular 10 to 1000, in particular 20 to 500, more particular 30 to 500, more particular 50 to 500, more particular 50 to 300.

The crossing number along the loops, in particular each loop, as defined herein is the number of crossings formed at different positions when staring at any crossing of the corresponding loop and counting the number of crossings formed by this loop until one comes back to the crossing of this loop at which one has started.

In some embodiments, the filament encloses a plurality of air bubbles. Such bubbles improve the stretchability, respectively elasticity, of the outsole.

In certain embodiments, the different property of the first area and the second area may be a different crossing number along the loops, in particular each loop, in these areas. For example, the crossing number in the first area may be higher than in the second area. It may for example be possible that the ratio of the crossing number along the loops, in particular each loop, in the second area to the crossing number along the loops, in particular each loop, in the first area may be between 0.05 to 0.7, in particular 0.1 to 0.7.

In some embodiments, the filament consists of polymer chains. Preferably, the polymer chains of the filament are aligned with each other, i.e. on an intermolecular level aligned with each other. This means that the polymer chains extend along the filament essentially in parallel to each other. Such outsoles have the advantage that they show an increased force transmission throughout the outsole.

In some embodiments, the filament path partially overlaps with itself within the outsole. It may for example be the case that a first section of the filament path which comprises or consists of a plurality of superimposed loops is partially overlapped by a second section of the filament path. The second section of the filament path may for example be arranged downstream along the filament path of the first section of the filament path. Such a first and second section which partially overlap each other may in some embodiments be consecutively, i.e. directly adjacently, behind each other, or they may be separated from each other by an intermediate section of the filament path. In such embodiments, a loop of the first section of the filament path may on the one hand be arranged underneath a next adjacently arranged (i.e. downstream) loop or multiple loops of the first section, and on the other hand also underneath loops being arranged along the filament path in the second section of the filament path, i.e. downstream of the first section of the filament path. As an example, the first section of the filament path may be linear in a first direction x and the second section of the filament path may also be linear, but extend in the opposite direction −x. Since the first and second section only partially overlap, they are in another direction, e.g. in the y direction being perpendicular to direction x and −x, offset to each other. It may in another embodiment be the case that the filament path has the shape of a spiral, wherein the filament path overlaps itself within the outsole. That is, a first section of the filament path may be represented by the outermost coil of the spiral. A second section of the filament path may be arranged downstream, e.g. directly adjacent the first section forming a second coil and partially overlapping the first section. This second coil is arranged closer to the spiral's center. Then, a third section of the filament path may be arranged downstream of the second section in the shape of a third coil and partially overlapping the second section of the filament path. This may be repeated multiple times, e.g. with a 4th, 5th, 6th, 7th, 8th, 9th or 10th section of the filament path up to the spiral's center.

Depending on the application, the method of manufacturing a sole unit may be combined with the manufacturing of the upper. Thus, in some embodiments, the method further includes the step of manufacturing an upper portion. The step of manufacturing the upper portion may be performed simultaneously with, before or after the step of forming the outsole. For example, the molten polymer composition may be applied on the second surface of the midsole to form the outsole and it the polymer composition may further be applied, e.g. on a last and/or on the first surface of the upper and/or on the peripheral edge surface, to form the upper portion. The outsole and the upper may in some embodiments share at least one filament. In some embodiments, at least one filament, for example up to ten filaments, may extend from the outsole to the upper. However, it is also possible that the outsole and the upper do share a filament but may still be manufactured in a single operation. The upper portion is typically connected to the midsole, wherein the first surface of the midsole faces the upper. In some embodiments, the midsole provided in step a) of the method disclosed herein is connected or is about to be connected to an upper, wherein the first surface of the midsole faces the upper. These embodiments allow a streamlined manufacturing of the sole unit and the upper, i.e. optionally of a whole shoe. The entire process may be performed at a single location and with minimal waste, thereby making it cost efficient and environmentally friendly.

The molten polymer composition is applied on the second surface of the midsole in the form of a filament forming a plurality of loops on the second surface. Different methods are available to do this. For example, the method disclosed in patent application WO2022/069583A1 may be used, which is incorporated herein by reference, in particular with respect to the “Verfahren zur Herstellung eines Textilmaterials”, more particularly with respect to the method involving the nozzle and the pressured air disclosed therein. For example, it is possible that the at least one nozzle comprises an outlet opening and a plurality of air exit openings arranged around the outlet opening, from which during compressed air impinges on the molten polymer composition such that the molten polymer composition exiting the nozzle is applied to the second surface as a helical filament. In some embodiments, the compressed air from the air outlet openings impinges continuously or discontinuously on the molten polymer composition. The compressed air may for example impinge on the heated polymer composition with a pressure from 1.1 bar to 2 bar, preferably from 1.2 bar to 1.5 bar.

The method disclosed herein may also be used to personalize a sole unit. Thus, in some embodiments, the method of manufacturing a sole unit further comprises determining for an individual one or more individual traction regions on the second surface of the midsole, wherein during application of the molten polymer composition on the second surface, the molten polymer composition is applied to the individual traction regions.

A second aspect of the invention relates to a sole unit comprising a midsole and an outsole connected to the midsole. The sole unit is producible or produced by any of the embodiments of the process disclosed herein.

The present disclosure relates to a method of manufacturing a sole unit and to a sole unit manufactured according to this method. It is understood that these two aspects of the present disclosure are linked to each other in that the sole unit may be manufactured (i.e. is producible) by this method. Consequently, it is understood that embodiments described in the context of the outsole unit may also relate to the method, and conversely, embodiments described in the context of the method may also relate to the outsole per se, unless otherwise specified. For example, when it is specified that the applied molten polymer composition has a certain material composition, it is understood that this material composition is an embodiment of both the method and of the outsole per se.

As outlined above, the method may in some variants include further steps performed after application of the molten polymer composition on the second surface. For example, the method may comprise a first curing step and/or one or more post-processing steps, such as a second curing step and application of a traction pattern. These further steps may or may not influence the structural features of the outsole and, therefore, of the sole unit as a whole. For example, a material composition of the polymer composition is typically maintained throughout the different steps and is typically still a structural feature of the outsole of the sole unit per se. By contrast, embossing the outsole may, depending on the variant, influence a surface profile of the outsole.

In general, the outsole of the sole unit may relate to a post-cured outsole, i.e. an outsole obtained after subjecting a pre-cured outsole to a first curing step. In some variants, the outsole of the sole unit may relate to a post-processed outsole, i.e. e.g. an outsole obtained after subjecting the post-cured outsole to one or more further processing steps. It is also possible that the outsole of the sole unit comprises sections, areas or regions which have been subjected to a first curing step (but no post-processing step), and other sections, areas or regions which have additionally been post-processed. By default, features describing the outsole refer in general to the post-cured outsole, unless it is explicitly otherwise described or the context implies otherwise.

In some embodiments, the outsole has a thickness from 50 micrometers to 1 cm, typically up to 7 mm. The thickness may for example relate to the post-cured outsole, and optionally also to the post-processed outsole.

Typically, the outsole is connected to the midsole, preferably directly to the midsole. For example, the outsole may contact the midsole directly, without any adhesive arranged between the outsole and the midsole.

The outsole may comprise one or more sections, which may be different from each other. The sections may for example include a forefoot outsole section, a heel outsole section and/or a midfoot outsole section.

In some embodiments, at least in some sections of the outsole (e.g. at least 10%, such as at least 25%, such as at least 50%, preferably at least 75%, more preferably 100%, of an outer surface of the outsole), the outsole comprises a polymer composition in the form of a filament forming a plurality of loops. Typically, the loops are not inter-looped, respectively entangled or chain linked with each other. The loops may be arranged partially on top of each other, respectively stacked on each other.

In some embodiments, at least in some sections of the outsole (e.g. at least 10%, such as at least 25%, such as at least 50%, preferably at least 75%, more preferably 100%, of an outer surface of the outsole), the outsole comprises up to 50, preferably up to 10, more preferably up to 5, more preferably one continuous filament. Depending on the application, each filament may form at least 100, in particular at least 1000, in particular at least 5000 loops. In some variants, each filament has a filament thickness from 0.01 mm to 5 mm, preferably from 0.01 mm to 0.2 mm, preferably from 0.05 mm to 0.15 mm.

In some embodiments, the outsole covers at least 10%, preferably at least 25%, more preferably at least 40%, of the second surface of the midsole.

In some embodiments, at least in some sections of the outsole (e.g. at least 10%, such as at least 25%, such as at least 50%, preferably at least 75%, more preferably 100%, of an outer surface of the outsole), the outsole comprises a polymer composition in the form of a filament forming a plurality of partially superimposed loops extending along a filament path. The plurality of partially superimposed loops may, for example, define a plurality of crossings at which the filament crosses itself and forms a material-bonded, in particular fused, connection with itself.

In some embodiments, at least in some sections of the outsole (e.g. at least 10%, such as at least 25%, such as at least 50%, preferably at least 75%, more preferably 100%, of an outer surface of the outsole), the outsole has a filament crossing density of at least 200 crossings per cm², in particular at least 300 crossings per cm², more particularly at least 500 crossings per cm². In some variants, the filament crossing density may at least 200 crossings per cm², in particular at least 300 crossing per cm², more particular at least 400 crossings per cm², more particular at least 500 crossings per cm², more particular at least 600 crossings per cm², even more particular at least 700 crossings per cm². In some variants, the filament crossing density may be 200 to 10000 crossings per cm², in particular of 200 to 5000 crossings per cm², in particular of 300 to 5000 crossings per cm², in particular of 300 to 3000 crossings per cm², in particular of 400 to 3000 crossings per cm². In some variants, the crossing density may be 400 to 10000 crossings per cm², in particular of 400 to 5000 crossings per cm², in particular of 400 to 5000 crossings per cm², in particular of 400 to 3000 crossings per cm², of 400 to 3000 crossings per cm².

In some embodiments, at least in some sections of the outsole (e.g. at least 10%, such as at least 25%, such as at least 50%, preferably at least 75%, more preferably 100%, of an outer surface of the outsole), the outsole has a filament loop density as defined herein of 0.5 to 15 loops per cm², in particular 0.7 to 10 loops per cm², more particular 0.7 to 5 loops per cm². As used herein, the loop density is the number of loops being formed by the filament per cm².

In some embodiments, at least in some sections of the outsole (e.g. at least 10%, such as at least 25%, such as at least 50%, preferably at least 75%, more preferably 100%, of an outer surface of the outsole), the filament or filaments form a plurality of fused bulge portions, formed from multiple fused together filament sections of the filament. The fused bulge portions may be formed from at least two, in particular at least three, in particular at least four, in particular at least five, in particular at least six, filament sections being fused together. In certain embodiments, multiple sections of the loops may be fused together in such fused bulge portions.

In some embodiments, at least in some sections of the outsole (e.g. at least 10%, such as at least 25%, such as at least 50%, preferably at least 75%, more preferably 100%, of an outer surface of the outsole), the partially superimposed loops are along the filament path arranged one after another and at least some, or the majority (more than 50%), or essentially all, of the superimposed loops, except the last loop (along the filament path) are arranged (e.g. partially arranged) underneath their next adjacently arranged loop. In other words, in such embodiments, the superimposed loops form together a roof tile structure in which the superimposed loops partially overlap and in which starting from the first loop, every loop except the last one is arranged partially underneath its next adjacent loop. In some embodiments, the partially superimposed loops are along the filament path arranged one after another, wherein the superimposed loops are along the filament path arranged underneath their next adjacently arranged loop. In some embodiments, each partially superimposed loop (except the last loop) is along the filament path arranged underneath their at least 2, at least 5, at least 10, or at least 15, next adjacently arranged loops. In some embodiments, each loop formed by the filament defines a maximum clear distance of 5 mm to 50 mm, in particular 5 mm to 30 mm.

In some embodiments, at least in some sections of the outsole (e.g. at least 10%, such as at least 25%, such as at least 50%, preferably at least 75%, more preferably 100%, of an outer surface of the outsole), the filament has a maximum filament thickness of 10 μm to 1000 μm, in particular 50 μm to 500 μm, more particular of 50 μm to 300 μm, even more particular of 75 μm to 250 μm.

In some embodiments, at least in some sections of the outsole (e.g. at least 10%, such as at least 25%, such as at least 50%, preferably at least 75%, more preferably 100%, of an outer surface of the outsole), the upper filament section at at least one, or at the majority (i.e. more than 50%), or at all crossings, is sank partially into the lower filament section. Further embodiments relating to partially sank arrangements are disclosed above.

In some embodiments, at least in some sections of the outsole (e.g. at least 10%, such as at least 25%, such as at least 50%, preferably at least 75%, more preferably 100%, of an outer surface of the outsole), the at least one, or the majority (i.e. more than 50%), or even all of the crossings may comprise or be a protuberance. Such a protuberance may generally be formed by the filament. In some variants, the upper filament section is at at least one, or at the majority (i.e. more than 50%), or at all crossings, sank such into the lower filament section that the crossing has a height being between 10% to 50%, in particular 15% to 30% larger than the maximum filament thickness.

In some embodiments, at least in some sections of the outsole (e.g. at least 10%, such as at least 25%, such as at least 50%, preferably at least 75%, more preferably 100%, of an outer surface of the outsole), the height at at least one, or at the majority (i.e. more than 50%), or at all crossings is between 10 to 50 μm, in particular 10 to 30 μm larger, than the maximum filament thickness.

In some embodiments, at least in some sections of the outsole (e.g. at least 10%, such as at least 25%, such as at least 50%, preferably at least 75%, more preferably 100%, of an outer surface of the outsole), at least one, or the majority (i.e. more than 50%), or all crossings, have a crossing length, i.e. the total extension of crossing along each filament section of the crossing (i.e. the upper or lower filament section) of between 50 to 500 μm, in particular 50 to 250 μm, more particular 100 to 200 μm.

In some embodiments, at least in some sections of the outsole (e.g. at least 10%, such as at least 25%, such as at least 50%, preferably at least 75%, more preferably 100%, of an outer surface of the outsole), the at least one, or the majority (i.e. more than 50%), or even all of the crossings may comprise or be a protuberance.

In some embodiments, at least in some sections of the outsole (e.g. at least 10%, such as at least 25%, such as at least 50%, preferably at least 75%, more preferably 100%, of an outer surface of the outsole), the respective section is formed from a single filament. In some variants, the entire outsole is formed from a single filament.

In some embodiments, the outsole is in direct contact with the second surface and with the peripheral edge surface. Thus, the outsole may extend to the peripheral edge surface.

Depending on the application, the outsole and the upper may be formed in a single operation. For example, in some embodiments, the outsole and the upper may be integrally formed. In some embodiments, the outsole and the upper are formed in one piece. In some embodiments, the upper and the outsole share at least one common filament. The upper and the outsole may also share up to ten filaments. It is also possible that the upper and the outsole are each formed in a single operation and that they are both connected directly to the midsole.

In some embodiments, the outsole comprises one or more of the following outsole sections:
a heel outsole section;
a midfoot outsole section;
a forefoot outsole section;
a medial outsole section and/or
a lateral outsole section.

In some embodiments, at least in some sections of the outsole (e.g. at least 10%, such as at least 25%, such as at least 50%, preferably at least 75%, more preferably 100%, of an outer surface of the outsole), the outsole comprises a plurality of elevations, for example at least five, preferably at least ten, more preferably at least 20, even more preferably at least 50, elevations may be formed. An elevation typically has a surface area of at least 0.5 mm², preferably from 1 mm² to 100 mm². Typically, an elevation has an elevation height of at least 0.5 mm, preferably at least 1 mm.

In some embodiments, at least in some sections of the outsole (e.g. at least 10%, such as at least 25%, such as at least 50%, preferably at least 75%, more preferably 100%, of an outer surface of the outsole), the outsole comprises one or more grooves. A groove may for example have a groove height of at least 0.5 mm, preferably of at least 1 mm.

In some embodiments, at least in some sections of the outsole (e.g. at least 10%, such as at least 25%, such as at least 50%, preferably at least 75%, more preferably 100%, of an outer surface of the outsole), the filament comprises along the loops, in particular along each loop, except the first and last loop, a crossing number as defined herein of at least 10, in particular at least 20, in particular at least 30, in particular at least 50, in particular at least 100, in particular at least 200. In some variants, at least in some sections of the outsole (e.g. at least 10%, such as at least 25%, such as at least 50%, preferably at least 75%, more preferably 100%, of an outer surface of the outsole), the filament comprises along the loops, in particular along each loop, except the first and last loop, a crossing number as defined herein of 10 to 5000, in particular 10 to 1000, in particular 20 to 500, more particular 30 to 500, more particular 50 to 500, more particular 50 to 300.

In some embodiments, at least in some sections of the outsole (e.g. at least 10%, such as at least 25%, such as at least 50%, preferably at least 75%, more preferably 100%, of an outer surface of the outsole), the filament encloses a plurality of air bubbles.

In some embodiments, at least in some sections of the outsole (e.g. at least 10%, such as at least 25%, such as at least 50%, preferably at least 75%, more preferably 100%, of an outer surface of the outsole), the filament path partially overlaps with itself within the outsole. It may for example be the case that a first section of the filament path which comprises or consists of a plurality of superimposed loops is partially overlapped by a second section of the filament path.

In the previous paragraphs, it was specified on multiple occasions in the context of several variants that a given structural feature may relate to “at least some sections of the outsole (e.g. at least 10%, such as at least 25%, such as at least 50%, preferably at least 75%, more preferably 100%, of an outer surface of the outsole)”. The outer surface of the outsole in this specification relates to a surface of the outsole that is arranged opposite the midsole. The outer surface of the outsole may also be labelled as ground-facing surface of the midsole. If the outsole is only arranged on part of the second surface of the midsole, the outer surface of the outsole typically does not include those parts of the second surface on which no outsole is arranged.

The present disclosure further relates to a shoe comprising the sole structure according to any one of the embodiments disclosed herein, and a textile material, in particular a shoe upper. The upper is typically arranged such that the first surface of the midsole faces the upper and that the second surface of the midsole faces away from the upper. The upper may, for example, be connected directly to the midsole. Depending on the application, the shoe may consist of the sole structure and the upper.

The upper may, for example, in some embodiments comprise a medial side and a lateral side. The upper may further comprise a heel area with a heel edge, a forefoot area with a tip and a midfoot area being arranged between the heel area and the forefoot area. The heel edge represents along the longitudinal direction the rear delimitation of the upper and extends in the worn state being used in a shoe along the wearer's Achilles' tendon. The tip is oppositely arranged to the heel edge and represents in the worn state being used in a shoe, the foremost delimitation of the upper. The upper may further comprise an instep area which extends from the medial side of the upper to the lateral side of the upper and in the worn state and being used in a shoe over the wearer's instep. In conventional uppers, the instep area is formed by the tongue and the lacing. Furthermore, the upper may comprise a peripheral bottom section. The peripheral bottom section represents on the medial and lateral side the peripheral delimitation of the upper. When used in a shoe, the peripheral bottom section is typically connected to the sole unit and forms the interface to the sole unit, respectively the connection area.

Directional indications as used in the present disclosure are to be understood as follows: The longitudinal direction LO of the sole unit, respectively the shoe, is described by an axis from the heel section, respectively from the heel edge, to the forefoot section, respectively to the tip, and thus extends along the longitudinal axis of the sole unit, respectively the shoe. The transverse direction TR of the sole unit, respectively the shoe, extends transversely to the longitudinal axis substantially parallel to the ground in the worn state. Thus, the transverse direction runs along a transverse axis of the sole unit, respectively the shoe. In the context of the present invention, the vertical direction V runs along a vertical axis of the sole unit, respectively the shoe. The longitudinal direction, the vertical direction and the transverse direction may all be perpendicular to each other. The lateral side of the sole unit, respectively the shoe, is the outer perimeter of the sole unit, respectively the shoe, between the heel edge and the tip. The medial side of the sole unit, respectively the shoe, refers to the inner perimeter of the sole unit, respectively the shoe, between the heel edge and the tip, which is located opposite the lateral side. Thus, in a pair of worn shoes, the medial sides of the two shoes face each other and the lateral sides face away from each other. Both the medial side and the lateral side each extend from the heel edge to the tip and meet each other at the tip and the heel edge. Furthermore, the sole unit, respectively the shoe, may typically along the longitudinal direction be divided into a forefoot section, a heel section and a midfoot section being arranged between the forefoot area and the heel area. For example, the forefoot section extends from the tip against, i.e. opposite, the longitudinal direction to 30-45% of the total length of the upper, respectively the shoe, in the longitudinal direction. The heel section extends, for example, from the heel edge in the longitudinal direction to 20-30% of the total length of the upper, respectively the shoe, in the longitudinal direction. The midfoot section extends directly between the heel area and the forefoot section, such that the length in the longitudinal direction of the midfoot section makes up the remaining portion of the total length, particularly from 15-50% of the total length.

In some embodiments, the upper may consist of a single filament. In some embodiments, the upper is devoid of a lacing and/or any eyelets. In some embodiments, the upper, and in particular the filament of the upper, has a weight of 15 g to 50 g, in particular 15 g to 30 g. In some embodiments, the upper is devoid of any stitching in particular devoid of any spun yarn.

The upper defines a foot accommodation compartment and a foot access opening providing access to the foot accommodation compartment, in particular providing access for the wearer's foot.

### BRIEF DESCRIPTION OF SEVERAL VIEWS OF THE DRAWINGS

The disclosure described herein will be more fully understood from the detailed description given herein below and the accompanying drawings which should not be considered limiting to the disclosure described in the appended claims.

FIG. 1 shows a schematic representation of a sole unit according to an embodiment of the invention;

FIG. 2 shows a schematic representation of a sole unit according to another embodiment of the invention;

FIG. 3 is a microscopic image of a portion of an outsole of a sole unit according to an embodiment of the invention;

FIG. 4 is a microscopic image of a portion of an outsole of a sole unit according to an embodiment of the invention;

FIG. 5 is a microscopic image of a portion of an outsole of a sole unit according to an embodiment of the invention;

FIG. 6 is a microscopic image of a portion of an outsole of a sole unit according to an embodiment of the invention;

FIG. 7 is a microscopic image of a portion of an outsole of a sole unit according to an embodiment of the invention;

FIG. 8 shows an embodiment of a sole unit covering a midfoot section MS;

FIG. 9 shows an embodiment of a sole unit covering a heel section HS;

FIG. 10 shows an embodiment of a sole unit covering a heel section HS;

FIG. 11 illustrates an embodiment of the method of manufacturing a sole unit; and

FIG. 12 illustrates and embodiment in which the molten polymer composition is applied to the peripheral edge surface of a midsole.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

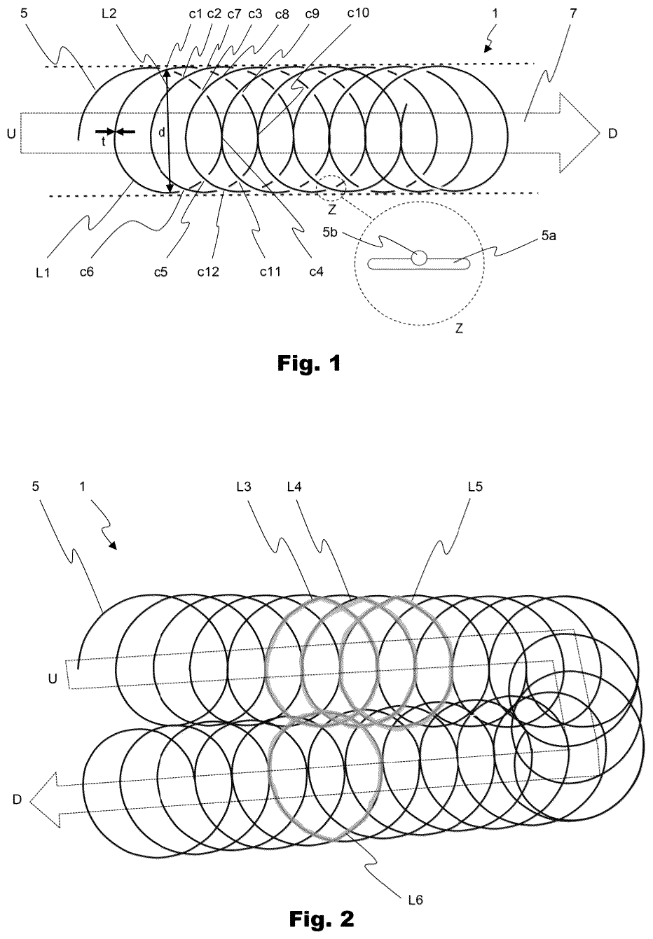

FIG. 1 shows a schematic representation of a sole unit 1 according to an embodiment of the invention. Sole unit 1 comprises filament 5 which extends along filament path 7. Filament path 7 is arranged between the two parallel dashed lines, which are aligned with the outer periphery of the loops firmed by filament 5. The filament path direction is indicated by the dashed arrow extending from upstream U to downstream D. It can be seen that filament 5 forms the entire sole unit 1. Filament 5 forms a plurality of superimposed loops L1, L2 (only two loops are referenced for clarity purposes). Each loop has a maximum clear distance d (indicated for loop L1). Furthermore, thermoplastic filament forms a plurality crossings c1, c2, c3, c4, c5, c5, c7, c8, c9, c10, c11 and c12 at which it crosses itself and at which it forms a direct, i.e. inherent, material-bonded connection with itself. Each of the crossings is formed from a lower filament section of the filament 5 and an upper filament section which is arranged on the lower filament section.

In FIG. 1 the thermoplastic filament is drawn with discontinuations at the crossing. This should not be interpreted as a break in the thermoplastic filament but merely serves to indicate which filament section is at each crossing on top and which below the other one. Filament 5 is in fact continuous throughout each of the loops shown. Loop L1 commences at its first crossing c1 along the filament path direction and ends again at crossing c1. Accordingly, loop L2 starts and ends at crossing c5. By virtue of the arrangement of filament 5 and in particular by the loops L1, L2, etc., a regular laid pattern is formed. The loops are not entangled with each other but rest on top of each other, that is, they form a laying or stack.

As can be seen, the loops formed by filament 5 are along filament path 7 in the filament path direction arranged one after another (that is, loop L1 is followed by loop L2, which is followed by subsequent loops). The superimposed loops are along the filament path arranged underneath their along the filament path 7 and in the filament path direction next adjacently arranged loop. For example, in FIG. 1 it can be seen that loop L1 is arranged underneath loop L2. In general, a loop (except the first loop L1) is arranged at least underneath its next downstream arranged loop (for example loop L1 is arranged underneath loop L2). However, as it is shown in FIG. 1, loop L1 is not only arranged underneath downstream loop L2, but also underneath the next downstream loop (see crossings c3 and c5). Filament 5 has a maximum filament thickness t as shown in FIG. 1.

Detailed view Z shows a schematic cross-sectional view through a crossing formed by filament 5. It can be seen that the crossing is formed from a corresponding lower filament section 2a and an upper filament section 2b, while the upper filament section 2b is partially, but not completely sank into the lower filament section 2a.

Loop L2 shown in FIG. 1 has a crossing number along the loop of 8 (crossing c7, c8, c9, c10, c11, c12, c6, c2).

FIG. 2 shows a schematic view of a sole unit 1 according to another embodiment of the invention. In contrast to FIG. 1 where the filament path extends linearly, the filament path along which filament 5 forms loops L3, L4, L5 and L7 does not extend only linearly, but comprises two curves, respectively two changes of direction as shown by the dashed arrow. In FIG. 2, the loops L3, L4, L5 and L7 are highlighted for illustrative purposes. Also in this embodiment, filament 5 forms a plurality of crossings with itself at which it forms a material-bonded connection with itself. As can be seen, the filament path overlaps itself in this embodiment. This has the effect that for example loop L3 is not only arranged underneath its directly adjacent loops L4 and L5, but also underneath much further downstream arranged loop L6. The upper part of the filament path, which comprises loops L3, L4 and L5 and which extends linearly up to the loop where the dashed arrow and thus the filament path undergoes a first directional change, can be considered a first section of the filament path. The lower part of the filament path, which comprises loop L6 and which extends linearly from the loop where the dashed arrow and thus the filament path undergoes a second directional change up to the last loop, can be considered a second section of the filament path. It can be seen that the second section of the filament path overlaps the first section of the filament path. This increases the crossing number of loop L3 as compared to loop L2 shown in FIG. 1. The crossing number along loop L3 in FIG. 2 is 15. Since each crossing forms a direct material-bonded connection, the outsole 1 shown in FIG. 2 has an enhanced tear resistance and shows a better force transmission through sole unit 1.

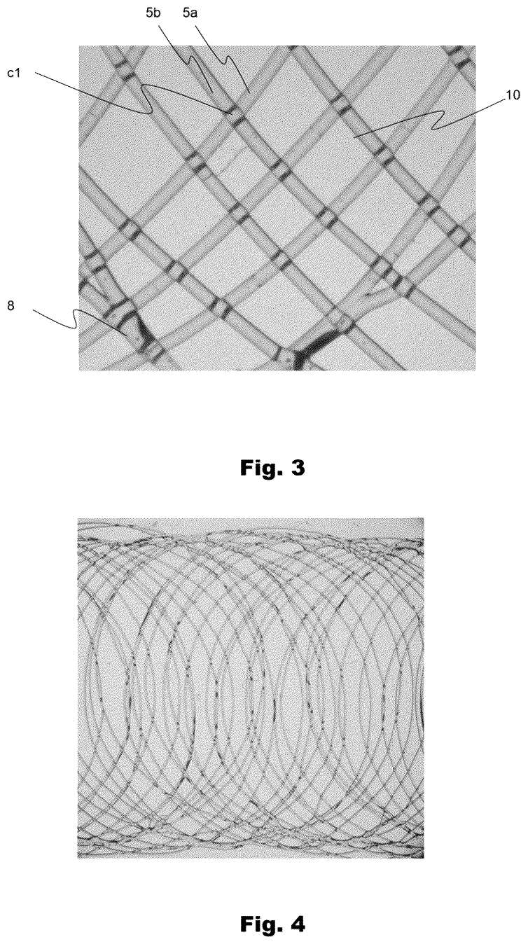

FIG. 3 shows a microscopic image of a section of an outsole of a sole unit which shows filament 5 forming loops and crossings, such as crossing c1 at which the thermoplastic filament crosses itself and form a material-bonded connection with itself. Furthermore, it can be seen that the thermoplastic filament, respectively the loops, define rhombic openings 10 which penetrate through the outsole. In addition, fused bulge portion 8 is formed by adjacent fusion of two filament sections.

FIG. 4 shows another microscopic image of an outsole of a sole unit forming a plurality of loops along a filament path. The image has a smaller magnification than the image shown in FIG. 3.

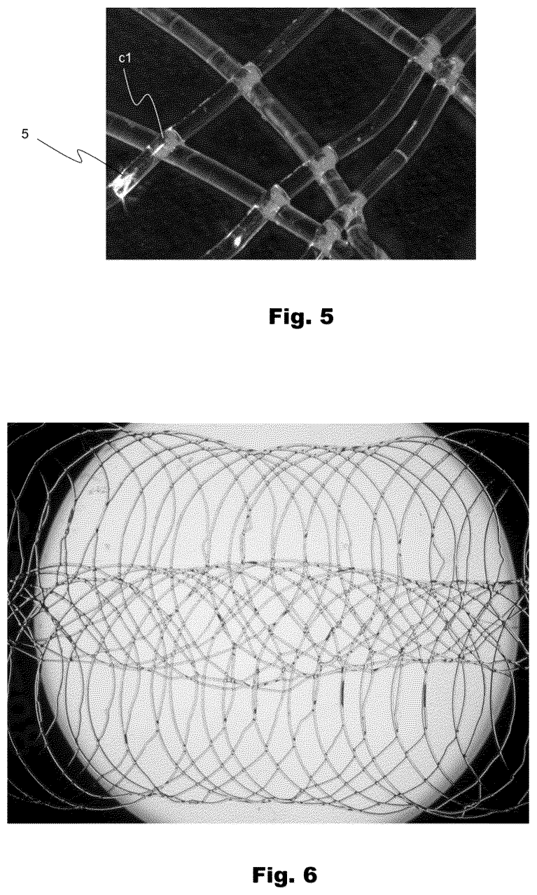

FIG. 5 shows an enlarged section of a microscopic image of an outsole of a sole unit according to an embodiment of the invention. In the image eight crossings formed by the filament 5 are shown. For example, it can be seen that crossing c1 is formed by a lower filament section upon which an upper filament section of filament 5 is arranged.

FIG. 6 shows a microscopic image of an outsole of a sole unit according to another embodiment of the invention. It can be seen that the filament 5 forms a plurality of loops along a filament path. Similar to the embodiment shown in FIG. 2, the filament path overlaps itself. A first section of the filament path (in this case the top row) is arranged on top of a second section of the filament path (in this case the bottom row).

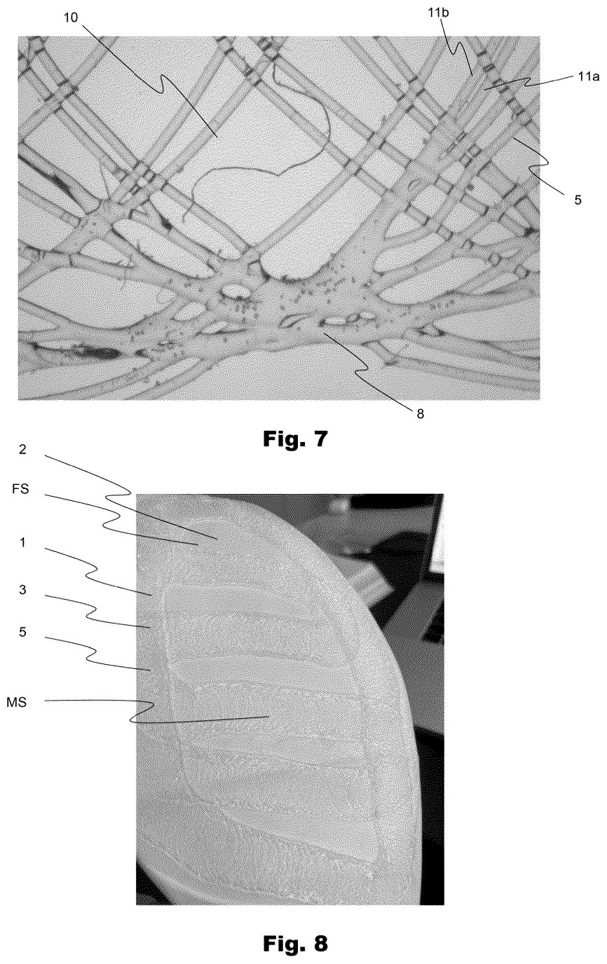

FIG. 7 shows another microscopic image of an outsole of a sole unit according to another embodiment of the invention, in which the thermoplastic filament forms fused bulge portion 8. As can be seen, two filament sections 11a and 11b of the filament 5 which each form a loop merge together at fused bulge portion 8.

FIG. 8 shows an embodiment of a sole unit 1. It comprises an outsole 3 which is in direct contact with a midsole 2. The outsole 3 covers a part of the surface area of the second surface of the outsole 3. The outsole 3 consists of a single filament, which forms a plurality of loops. The outsole 3 covers a forefoot section FS and a midfoot section MS.

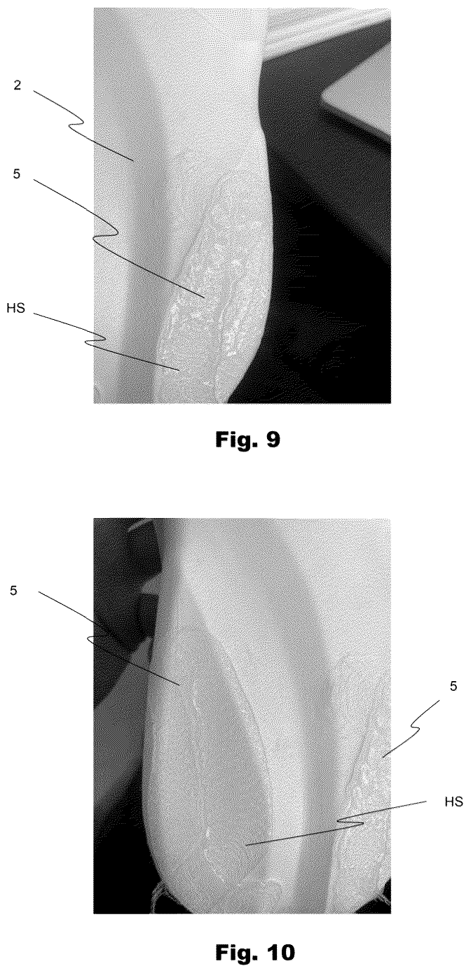

FIG. 9 shows a further embodiment of a sole unit 1. It also comprises an outsole 3 which is in direct contact with a midsole 2. The outsole 3 also consists of a single filament, which was applied to the midsole 2 in form of a plurality of loops. The outsole 3 covers a heel section HS.

FIG. 10 shows yet a further embodiment of a sole unit 1. It also comprises an outsole 3 which is in direct contact with a midsole 2. The outsole 3 also consists of a single filament, which was applied to the midsole 2 in form of a plurality of loops. The outsole 3 covers a heel section HS, specifically a medial heel section and a lateral heel section.

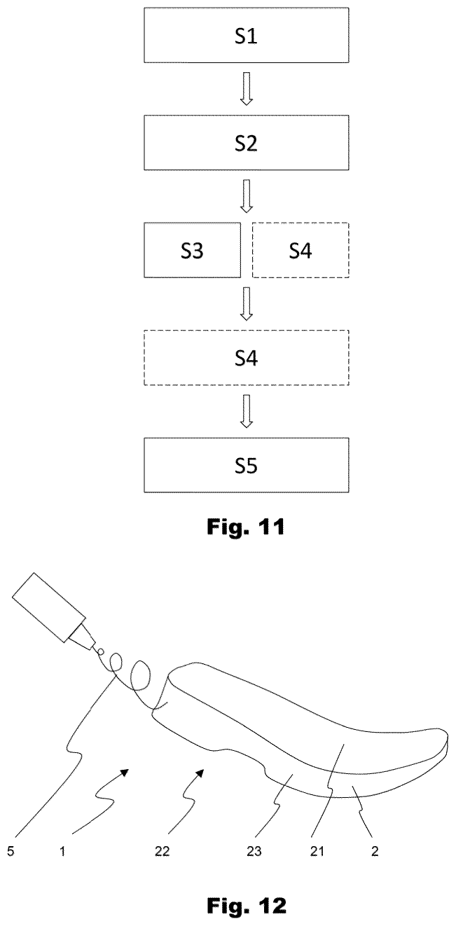

FIG. 11 illustrates an embodiment of a method of manufacturing a sole unit. In this embodiment, the method comprises a first step S1 of providing a midsole 2 which has a first surface 21, an opposite second surface 22 and a peripheral edge surface 23. In a subsequent second step S2, a polymer composition is molten at a first temperature. In a subsequent third step S3, the molten polymer composition is applied on the second surface of the midsole in the form of a filament 5 forming a plurality of loops on the second surface, thereby forming an outsole 3. In a fourth step S4, which may occur simultaneously with or subsequently to (as indicated by the hashed lines) the third step S3, the molten polymer composition is cured by exposing it to room temperature for at least five seconds. In a subsequent fifth step S5, the cured outsole is subjected to one or more post-processing steps, for example embossing.

FIG. 12 illustrates an embodiment in which the molten polymer composition is applied to the peripheral edge surface of a midsole. Specifically, the figure illustrates a midsole 2 having a first surface 21 configured to face an upper (not illustrated), an opposite second surface 22 and a peripheral edge surface 23 interconnecting in circumferential direction the first and second surface 21, 22. The peripheral edge surface 23 includes a medial side and a lateral side.

In the embodiment illustrated in FIG. 12, the molten polymer composition in the form of a filament 5 is applied to the peripheral edge surface 23. Specifically, the molten polymer composition is applied to the peripheral edge surface 23 such that after its application, the polymer composition extends along the entire height of the midsole 2. The height of the midsole refers to the extension in the vertical direction from the second surface 22 to the first surface 21. Optionally, the applied polymer composition may also cover the entire peripheral edge surface 23 in circumferential direction, including the entire medial section of the peripheral edge surface 23, the entire lateral section of the peripheral edge surface 23, the entire heel section of the peripheral edge surface 23 and the entire forefoot section of the peripheral edge surface 23.

1. A method of manufacturing a sole unit (1) having a midsole (2) and an outsole (3) being connected to the midsole (2), the method comprising:
a. providing a midsole (2) having a first surface (21) configured to face an upper (4), an opposite second surface (22) and a peripheral edge surface (23);
b. melting a polymer composition at a first temperature to provide a molten polymer composition; and
c. applying the molten polymer composition on the second surface of the midsole in the form of a filament (5) forming a plurality of loops (L1, L2, L3, L4, L5, L6) on the second surface (22), thereby forming an outsole (3).

2. The method according to claim 1, wherein the filament (5) has a filament thickness from 0.01 mm to 5 mm, preferably from 0.01 mm to 0.2 mm, preferably from 0.05 mm to 0.15 mm.

3. The method according to claim 1, wherein the molten polymer composition is applied on the second surface in the form of a filament (5) forming a plurality of partially superimposed loops (L1, L2, L3, L4, L5, L6) extending along a filament path (7).

4. The method according to claim 3, wherein the plurality of partially superimposed loops (L1, L2, L3, L4, L5, L6) define a plurality of crossings (c1, c2, c3, c4, c5, c6, c7, c8, c9, c10, c11, c12) at which the filament crosses itself and forms a material-bonded, fused connection with itself.

5. The method according to claim 4, wherein the molten polymer composition is applied on the second surface at a filament crossing density of at least 200 crossings per cm², in particular at least 300 crossings per cm², more particularly at least 500 crossings per cm².

6. The method according to claim 3, wherein the plurality of superimposed loops (L1, L2, L3, L4, L5, L6) are stacked on top of each other along the filament path (7).

7. The method according to claim 1, wherein the filament is applied such that it forms a plurality of fused bulge portions (8), formed from multiple fused together filament sections of the filament (5).

8. The method according to claim 1, further comprising the step of applying or embossing a traction pattern to the outsole (3).

9. The method according to claim 1, wherein step c) further comprises pre-conditioning an area of the second surface (22) of the midsole (2) before applying the molten polymer composition to that area, wherein the pre-conditioning comprises at least one of irradiating the area with plasma and heating the area with a hot air stream.

10. The method according to claim 1, wherein in step c., the molten polymer composition is additionally applied on the peripheral edge surface (23) of the midsole (2).

11. The method according to claim 1, wherein the molten polymer composition is applied to at least one of the following sections of the midsole (2):
a. a heel section of the second surface to provide a heel outsole section;
b. a midfoot section of the second surface to provide a midfoot outsole section;
c. a forefoot section of the second surface to provide a forefoot outsole section;
d. a medial section of the peripheral edge surface to provide a medial out-sole section;
e. a lateral section of the peripheral edge surface to provide a lateral out-sole section;
f. a heel section of the peripheral edge surface to provide a heel outsole section; and
g. a forefoot section of the peripheral edge surface to provide a forefoot outsole section.

12. The method according to claim 11, wherein each of the sections is formed from less than 100, preferably less than 30, more preferably less than 10, more preferably less than 5 continuous strands, more preferably from one continuous strand.

13. The method according to claim 1, wherein the midsole provided in step a) is connected to an upper (9), wherein the first surface (21) of the midsole faces the upper (9).

14. The method according to claim 1, wherein the polymer composition comprises at least one of TPU, polyamide, TPE, and PEBAX®.

15. A sole unit (1) comprising a midsole (2) and an outsole (3) connected to the mid-sole, produced by a method according to claim 1.

16. A shoe (100), comprising a sole unit (1) according to claim 15 and a textile material comprising a shoe upper (9).
